(19) United States
(12) Patent Application Publication
(10) Pub. No.: US 2005/0253343 A1
(43) Pub. Date: Nov. 17, 2005

(54) Housing seal with sealing material spanning a compliant channel

(76) Inventor: Steven W. Hampton, Mustang, OK (US)

Correspondence Address: Jennifer Buenzow;Seagate Technology LLC, Intellectual Property - SHK2LG, 1280 Disc Drive, Shakopee, MN, 55379, US

(21) Appl. No.: 10/847,279

(22) Filed: May 14, 2004

(51) Int. Cl. F16J 3/00

(52) U.S. Cl. 277/628

(57) ABSTRACT

Method and apparatus for sealing a housing, such as a housing of a data storage device. Opposing first and second housing members are provided with the first member having a groove formed by opposing sidewalls and a recessed surface at a distal extent of the groove. A sealing material spans the groove so that, upon compression of the material between said members, a unitary channel is formed by a medial portion of the sealing material, the opposing sidewalls and the recessed surface. Preferably, the first housing member comprises a substantially planar first surface into which the groove extends. The second housing member comprises a substantially planar second surface, and the sealing material is respectively compressed between the first and second surfaces on opposing sides of the groove. The channel preferably entraps a fluid such as air which compliantly supports the sealing material.

### FIELD OF THE INVENTION

The claimed invention relates generally to the field of housing structures and more particularly, but not by way of limitation, to an apparatus and method for forming a housing seal.

### BACKGROUND

Disc drives are digital data storage devices which store and retrieve large amounts of user data in a fast and efficient manner. The data are magnetically recorded on the surfaces of one or more data storage discs (media) affixed to a spindle motor for rotation at a constant high speed.

An array of vertically aligned data transducing heads are controllably positioned by an actuator to read data from and write data to tracks defined on the recording surfaces. An actuator motor rotates the actuator to move the heads across the disc surfaces. The heads are configured to be hydrodynamically supported adjacent the disc surfaces by fluidic pressures established by the high speed rotation of the discs.

It is generally desirable to enclose the heads and recording media in a sealed housing to protect these components from the deleterious effects of fluid-borne contaminants from the surrounding atmosphere. Some device designers have proposed hermetically sealed designs that contain a lower density atmosphere within the housing, such as an inert gas (helium, etc.), to reduce windage and vibration effects and achieve higher levels of operational performance.

With the continued demand for higher performance data storage devices, there remains a continual need for improved housing seal configurations. It is to these and other improvements that the claimed invention is generally directed.

### SUMMARY OF THE INVENTION

As embodied herein and as claimed below, the present invention is generally directed to an apparatus and method for sealing a housing.

In accordance with some preferred embodiments, the apparatus comprises opposing first and second housing members, the first member having a groove formed by opposing sidewalls and a recessed surface at a distal extent of the groove.

A sealing material spans the groove so that, upon compression of the material between said members, a unitary channel is formed by a medial portion of the sealing material, the opposing sidewalls and the recessed surface.

The groove preferably extends adjacent a peripheral edge of the first housing member so that the sealing material and the first and second housing members form an enclosed, sealed housing. The channel preferably entraps a fluid, such as air, which operates as a compliant member to support the sealing member.

Preferably, the first housing member comprises a substantially planar first surface into which the groove partially extends. The second housing member comprises a substantially planar second surface, and the sealing material is respectively compressed between the first and second surfaces on opposing sides of the groove.

In accordance with further preferred embodiments, the method comprises providing opposing first and second housing members, the first housing member having a groove formed by opposing sidewalls and a recessed surface at a distal extent.

The method further comprises compressing a sealing material between the first and second housing members, the sealing member spanning the groove so that a unitary channel is formed by a medial portion of the sealing material, the opposing sidewalls and the recessed surface.

The compressing step preferably entraps a fluid within said channel to provide compliant support of the sealing material. The method further preferably comprises applying the sealing material as a bead to a selected one of the first and second housing members in alignment with the groove to form a form in place gasket (FIPG).

The providing step preferably comprises supplying the first housing member with a substantially planar first surface into which the groove extends and the second housing member with a substantially planar second surface, and the compressing step further preferably comprises respectively compressing the sealing material between the first and second surfaces on opposing sides of the groove.

These and various other features and advantages which characterize the claimed invention will become apparent upon reading the following detailed description and upon reviewing the associated drawings.

### BRIEF DESCRIPTION OF THE DRAWINGS

FIG. 1 is an exploded, perspective view of a data storage device constructed in accordance with preferred embodiments of the present invention.

FIG. 2 is a side elevational, cross-sectional exploded view of a portion of the housing of the device of FIG. 1 to illustrate a sealing arrangement in accordance with a first preferred embodiment.

FIG. 3 shows the various components in FIG. 2 in a final, assembled state.

FIG. 4 illustrates an alternative preferred embodiment for the sealing arrangement of FIGS. 2 and 3.

FIG. 5 illustrates yet another alternative preferred embodiment for the sealing arrangement of FIGS. 2 and 3.

### DETAILED DESCRIPTION

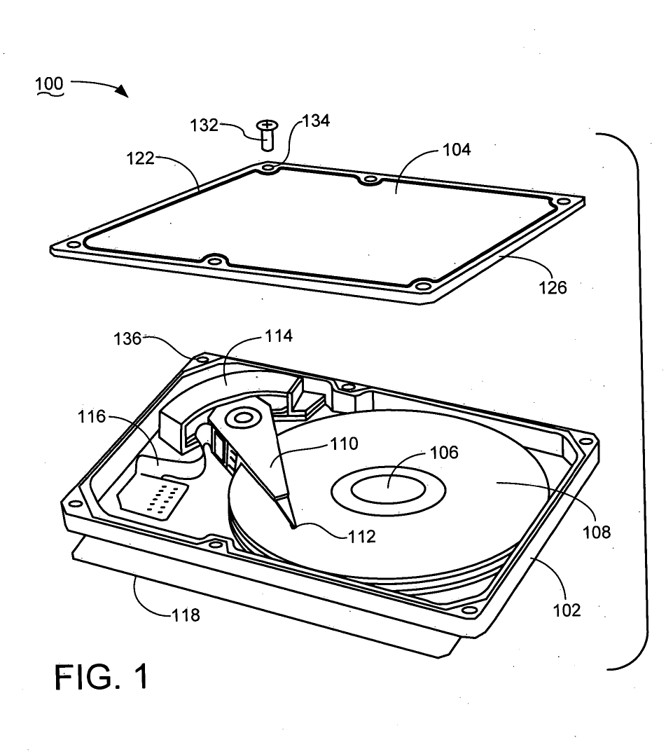

While the claimed invention has utility in any number of different applications, FIG. 1 has been provided to illustrate a particularly suitable environment in which the claimed invention can be advantageously practiced.

FIG. 1 shows an exploded, perspective top plan representation of a data storage device 100 of the type used to magnetically store and retrieve computerized user data. The device 100 includes a sealed housing formed from a base deck 102 and a top cover 104.

The sealed housing provides a controlled interior environment for various constituent components of the device 100, including a spindle motor 106 which rotates a number of data recording discs 108, and an actuator 110 which supports a corresponding array of data transducing heads 112 adjacent the disc surfaces.

The actuator 110 is controllably positioned by a voice coil motor (VCM) 114 which aligns the heads 112 with tracks (not shown) defined on the disc surfaces. A flex circuit assembly 116 provides electrical communication paths between the actuator 110 and control electronics supported on a printed circuit board assembly (PCBA) 118 mounted to the underside of the base deck 102.

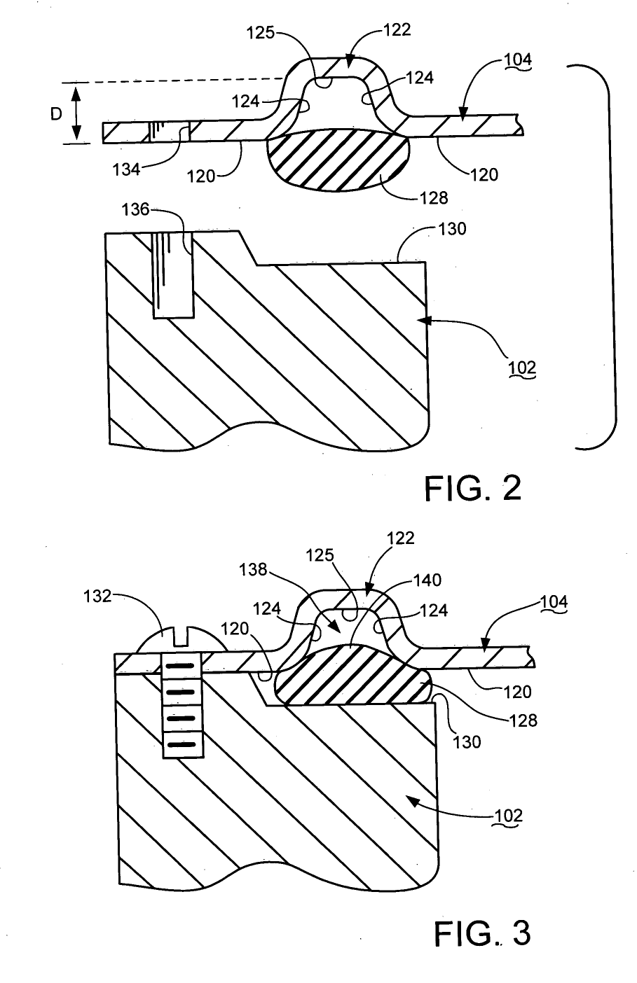

Of particular interest to the present discussion is the manner in which the top cover 104 mates with the base deck 102 to form the sealed housing. A first preferred embodiment is shown in FIGS. 2 and 3.

FIG. 2 shows the top cover 104 to include a substantially planar first surface 120 into which extends a groove 122. The groove 122 is formed by opposing sidewalls 124 and a recessed surface 125 at a distal extent of maximum depth D. While the groove 122 has a substantially trapezoidal configuration, other cross-sectional shapes can be used as desired.

The groove 122 circumferentially extends adjacent a peripheral edge 126 of the top cover 104, as depicted in FIG. 1. The top cover 104 is preferably formed from sheet stock aluminum and the groove 122 is preferably formed using a suitable stamping operation, although other materials and processing methodologies can be employed.

A suitable sealing material 128 spans the groove 122. The sealing material preferably comprises a bead of viscous elastomeric material that is controllably applied to the top cover 104 to provide a form in place gasket (FIPG). Other sealing materials and configurations can be used, however, such as a preformed gasket having a selected cross-sectional shape, such as circular (i.e., a hollow or solid o-ring).

The base deck 102 in FIG. 2 is provided with a substantially planar second surface 130 in facing relationship with the first surface 120. During assembly, the top cover 104 is brought into alignment with the base deck 102 so that the sealing material 128 contactingly engages the second surface 130. Threaded fasteners 132 are inserted into through-hole apertures 134 in the top cover 104 and threaded apertures 136 in the base deck 102. This secures the top cover 104 to the base deck 102 and compresses the sealing material 128 between the surfaces 120 and 130 on opposing sides of the groove 122, as depicted in FIG. 3.

Upon compression of the sealing material 128, a portion of the material partially extends into the groove 122, leaving a gap between the sealing material 128 and the recessed surface 125. A unitary channel 138 is accordingly formed by a medial portion 140 of the sealing material, the opposing sidewalls 124 and the recessed surface 125, said channel extending along the length of the groove. The channel 138 preferably serves to entrap a fluid (such as air) to compliantly support the sealing material 128.

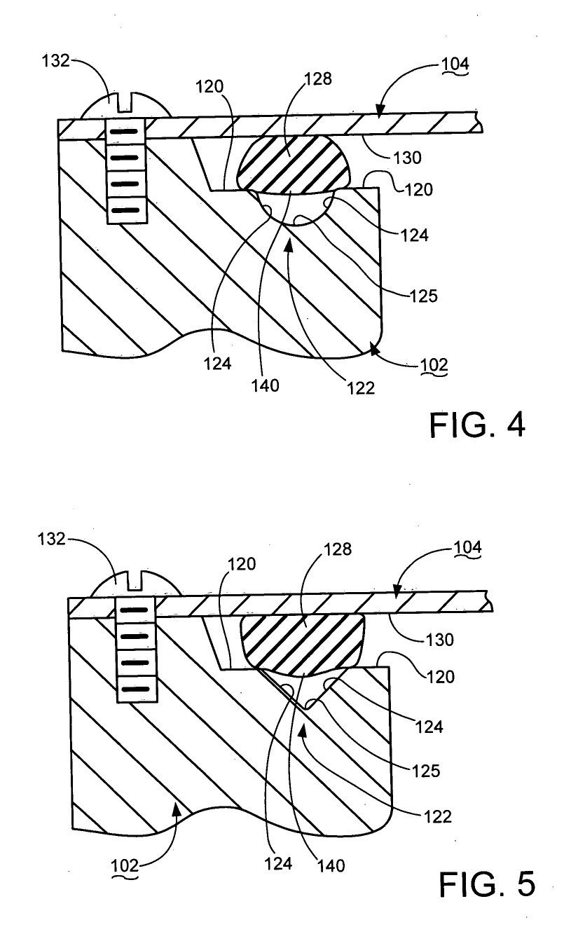

FIG. 4 provides an alternative to the embodiment of FIGS. 2-3. In FIG. 4, the first surface 120 and the groove 122 are formed in the base deck 102 and the sealing material 128 is applied thereto prior to attachment of the top cover 104. The groove 122 in FIG. 4 is shown to have a semi-circular cross-sectional shape. The base deck 102 is preferably formed from cast aluminum, in which case the groove 122 in FIG. 4 can be formed during the molding process.

FIG. 5 provides another alternative similar to that of FIG. 4. In FIG. 5, the groove 122 is formed in the base deck 102 as before, but the sealing material 128 is applied to the top cover 104 instead of to the base deck 102. The groove 122 in FIG. 5 is also shown to have a substantially triangular cross-sectional shape.

It will be noted that the various preferred embodiments presented herein provide certain advantages over the prior art. The embodiments are easily manufactured and accept tolerance variations within ranges that are readily achievable using standard manufacturing processes.

The entrapped fluid in the channel operates as a compliant member that supports the sealing material so that lower compression forces can be utilized during the clamping of the top cover to the base deck. This eliminates the need for the addition of expensive structural members or extra material as in prior art designs.

Also, the need to machine or otherwise precision form the path for a preformed sealing gasket (such as in the base deck) can be eliminated, as well as the sorting of various housing members during the manufacturing process to locate base deck/top cover pairs with desired dimensions and/or tolerances.

It will now be understood that the present invention (as embodied herein and as claimed below is generally directed to an apparatus and method for sealing a housing.

In accordance with some preferred embodiments, the apparatus comprises opposing first and second housing members (such as 102 and 104), said first member having a groove (such as 122) formed by opposing sidewalls (such as 124) and a recessed surface (such as 125) at a distal extent (such as distance D).

A sealing material (such as 128) spans the groove so that, upon compression of the material between said members, a unitary channel (such as 138) is formed by a medial portion (such as 140) of the sealing material, the opposing sidewalls (such as 125) and the recessed surface (such as 124).

The groove preferably extends adjacent a peripheral edge (such as 126) of the first housing member so that the sealing material and the first and second housing members form an enclosed, sealed housing. The channel preferably entraps a fluid, such as air, which operates as a compliant member to support the sealing member.

Preferably, the first housing member comprises a substantially planar first surface (such as 120) into which the groove partially extends. The second housing member comprises a substantially planar second surface (such as 130), and the sealing material is respectively compressed between the first and second surfaces on opposing sides of the groove.

In accordance with further preferred embodiments, the method comprises providing opposing first and second housing members (such as 102, 104), the first housing member having a groove (such as 122) formed by opposing sidewalls (such as 124) and a recessed surface (such as 125) at a distal extent (such as distance D).

The method further-comprises compressing a sealing material (such as 128) between the first and second housing members, the sealing member spanning the groove so that a unitary channel (such as 138) is formed by a medial portion (such as 140) of the sealing material, the opposing sidewalls (such as 124) and the recessed surface (such as 125).

The compressing step preferably entraps a fluid within said channel to provide compliant support of the sealing material. The method further preferably comprises applying the sealing material as a bead to a selected one of the first and second housing members in alignment with the groove to form a form in place gasket (FIPG).

The providing step preferably comprises supplying the first housing member with a substantially planar first surface (such as 120) into which the groove extends and the second housing member with a substantially planar second surface (130), and the compressing step preferably comprises respectively compressing the sealing material between the first and second surfaces on opposing sides of the groove.

For purposes of the appended claims, the term “unitary channel” will be defined consistent with the foregoing discussion as a single, continuous channel that extends along the length of the groove (such as 122) as a result of noncontact between the sealing material (such as 128) and the recessed surface (such as 125).

The term “distal extent” will be defined consistent with the foregoing discussion to describe a maximum depth distance of the gap (such as the distance D shown in FIG. 2).

The recited “first means” will be understood to correspond to at least the sealing material 128, the groove 122 and the unitary channel 138, as shown in FIGS. 2-5.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application of the housing without departing from the spirit and scope of the present invention.

In addition, although the embodiments described herein are directed to the sealing of a data storage device housing, it will be appreciated by those skilled in the art that the claimed subject matter is not so limited, but rather extends to any number of different housing applications.

1. An apparatus, comprising:
opposing first and second housing members, said first member having a groove formed by opposing sidewalls and a recessed surface at a distal extent; and
a sealing material spanning the groove so that, upon compression of the material between said members, a unitary channel is formed by a medial portion of the sealing material, the opposing sidewalls and the recessed surface.

2. The apparatus of claim 1, wherein the channel entraps a fluid which compliantly supports the sealing material.

3. The apparatus of claim 1, wherein the first housing member comprises a substantially planar first surface into which the groove partially extends, wherein the second housing member comprises a substantially planar second surface, and wherein the sealing material is respectively compressed between the first and second surfaces on opposing sides of the groove.

4. The apparatus of claim 1, wherein the sealing material comprises a form in place gasket (FIPG).

5. The apparatus of claim 1, wherein upon compression of the sealing material the medial portion partially extends into the groove.

6. The apparatus of claim 1, wherein the groove extends adjacent a peripheral edge of the first housing member.

7. The apparatus of claim 1, wherein the first and second housing members form a housing for a data storage device.

8. An apparatus comprising opposing first and second housing members, and first for establishing a compliant seal therebetween.

9. A method comprising:
providing opposing first and second housing members, the first housing member having a groove formed by opposing sidewalls and a recessed surface at a distal extent; and
compressing a sealing material between the first and second housing members, the sealing member spanning the groove so that a unitary channel is formed by a medial portion of the sealing material, the opposing sidewalls and the recessed surface.

10. The method of claim 9, wherein the compressing step comprises entrapping a fluid within said channel to provide compliant support of the sealing material.

11. The method of claim 9, further comprising applying the sealing material as a bead to a selected one of the first and second housing members in alignment with the groove to form a form in place gasket (FIPG).

12. The method of claim 9, wherein the providing step comprises supplying the first housing member with a substantially planar first surface into which the groove extends and the second housing member with a substantially planar second surface, and wherein the compressing step comprises respectively compressing the sealing material between the first and second surfaces on opposing sides of the groove.

13. The method of claim 9, wherein a portion of the sealing material extends into the groove during the compressing step in a noncontacting relationship with the recessed surface.

14. The method of claim 9, wherein the providing step comprises configuring the groove to extend adjacent a peripheral edge of the first housing member.

15. The method of claim 9, wherein the first and second housing members of the providing step are characterized housing members that form a housing for a data storage device.
